(19) United States
(12) Patent Application Publication
(10) Pub. No.: US 2010/0132552 A1
(43) Pub. Date: Jun. 3, 2010

(54) ZONE OR PROCESS FOR IMPROVING AN EFFICIENCY THEREOF

(76) Inventors: William J. Lechnick, Glen Ellyn, IL (US); Edward P. Zbacnik, Fox River Grove, IL (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(21) Appl. No.: 12/499,787

(22) Filed: Jul. 8, 2009

(51) Int. Cl. B01D 53/14; B01D 53/18

(52) U.S. Cl. 95/180; 96/181

(57) ABSTRACT

One exemplary embodiment can be a process for increasing an efficiency of an acid gas removal zone. The process may include passing an absorber-solvent cooling stream through a heat exchanger. Usually, the heat exchanger warms the absorber-solvent cooling stream with a lean solvent stream before removing at least a portion of the carbon dioxide remaining in the absorber-solvent cooling stream and returning a partially-lean solvent stream to an absorber.

### FIELD OF THE INVENTION

This invention generally relates to improving an efficiency of a zone or process.

### DESCRIPTION OF THE RELATED ART

Generally, gases produced in a refinery or a chemical manufacturing process can be utilized in other units in the facility. Moreover, sometimes gases that are generated are released to the environment. In either instance, often impurities are required to be removed before subsequent utilization or release. As an example, a synthetic gas (hereinafter may be abbreviated “syngas”) often includes hydrogen sulfide and carbon dioxide that can be removed by utilizing a refrigerated solvent fed to an absorber.

In such a process, the solvent rates can be up to and greater than about 40 meter-cubed per minute. These large solvent rates combined with operating pressures, sometimes greater than about 6,200 kPa, may result in electricity requirements exceeding about 5 megawatts.

Warming a solvent exiting a carbon dioxide absorber may reduce the solvent rate and electricity requirements by increasing flashing of carbon dioxide and reducing the carbon dioxide loading in a partially-lean solvent. Warming the solvent can reduce electricity usage and provide subsequent savings due to the reduced solvent rates in the pumps returning the partially-lean solvent to the carbon dioxide absorber.

However, typically the warmed, partially-lean solvent is refrigerated before returning to the absorber. Thus, the pump electricity savings can be offset by increased refrigeration requirements to re-cool the partially-lean solvent before entering the absorber. Refrigeration can be required to prevent excessively large solvent rates that produce unacceptable equipment sizing and capital costs for equipment such as a carbon dioxide absorber. Thus, it would be beneficial to utilize the cooling energy of the solvent when it is warmed prior to flashing.

### SUMMARY OF THE INVENTION

One exemplary embodiment can be a process for increasing an efficiency of an acid gas removal zone. The process may include passing an absorber-solvent cooling stream through a heat exchanger. Usually, the heat exchanger warms the absorber-solvent cooling stream with a lean solvent stream before removing at least a portion of the carbon dioxide remaining in the absorber-solvent cooling stream and returning a partially-lean solvent stream to an absorber.

Another exemplary embodiment may be a process for reducing the duty of a lean solvent stream chiller. The process may include passing an absorber-solvent cooling stream through a heat exchanger to warm the absorber-solvent cooling stream, while cooling a lean solvent stream before the lean solvent stream can enter the lean solvent stream chiller.

Yet another exemplary embodiment can be an acid gas removal zone. The acid gas removal zone may include an absorber, a heat exchanger, a high pressure flash drum, a medium pressure flash drum, a vacuum flash drum, and a partially-lean solvent stream chiller. The absorber may be adapted to receive a stream including at least one of hydrogen sulfide and carbon dioxide, and a lean solvent stream. Typically, the heat exchanger is adapted to warm an absorber-solvent cooling stream using the lean solvent stream provided to the absorber. Usually, the high pressure flash drum, the medium pressure flash drum, and the vacuum flash drum are adapted to receive the absorber-solvent cooling stream. The partially-lean solvent stream chiller can be adapted to receive a partially-lean solvent stream from the vacuum flash drum and to provide the partially-lean solvent stream to the absorber.

The embodiments provided herein can heat an absorber-solvent cooling stream by passing the stream through an exchanger on an opposing side to a lean solvent stream to reduce the solvent rate while recovering some of the refrigeration losses. In some preferred embodiments, the lean solvent stream exiting the exchanger can have a temperature of about 38° C. and can be further refrigerated prior to entering the carbon dioxide absorber. Typically, heat exchanging the absorber-solvent cooling and lean solvent streams enable some of the refrigeration energy lost by the absorber-solvent cooling stream to be recovered by the lean solvent stream before entering the absorber.

### Definitions

As used herein, the term “stream” can include a solvent and/or various hydrocarbon molecules, such as straight-chain, branched, or cyclic alkanes, alkenes, alkadienes, and alkynes, and optionally other substances, such as gases, e.g., hydrogen, or impurities, such as heavy metals, and sulfur and nitrogen compounds. The stream can also include aromatic and non-aromatic hydrocarbons. Moreover, the hydrocarbon molecules may be abbreviated C1, C2, C3 . . . Cn where “n” represents the number of carbon atoms in the one or more hydrocarbon molecules. Additionally, characterizing a stream as, e.g., a “partially-lean solvent stream” or a “lean solvent stream” can mean a stream including or rich in, respectively, at least one partially-lean solvent or lean solvent.

As used herein, the term “zone” can refer to an area including one or more equipment items and/or one or more sub-zones. Equipment items can include one or more reactors or reactor vessels, heaters, exchangers, pipes, pumps, compressors, and controllers. Additionally, an equipment item, such as a reactor, dryer, or vessel, can further include one or more zones or sub-zones.

As used herein, the term “cooler” can mean a device cooling a fluid with water.

As used herein, the term “chiller” can mean a device cooling a fluid to a temperature below that obtainable only by using water. Typically, a chiller may use a refrigerant such as ammonia or a hydrofluorocarbon.

As used herein, the term “rich” can mean an amount of at least generally about 5%, preferably about 30%, more preferably about 50%, and optimally about 70%, by mole, of a compound or class of compounds in a stream.

As used herein, the term “absorber” can include an adsorber, and relates, but is not limited to, absorption and/or adsorption.

As used herein, the terms “absorber-solvent cooling stream” can mean a stream taken from an absorber, typically near or at the bottom of the absorber, optionally passed through one or more flash drums, and used to cool an incoming stream to the absorber.

As depicted, process flow lines in the figures can be referred to as lines, feeds, effluents, streams, or portions. Particularly, a line can contain one or more feeds, effluents, streams, or portions.

### BRIEF DESCRIPTION OF THE DRAWINGS

FIG. 1 is a schematic depiction of an exemplary acid gas removal zone.

FIG. 2 is a schematic depiction of another version of an exemplary acid gas removal zone.

FIG. 3 is a schematic depiction of yet another version of the exemplary acid gas removal zone.

### DETAILED DESCRIPTION

An acid gas removal zone can utilize devices to remove components from a fluid stream. Typically, the device can be any suitable type for removing a desired fluid, such as a gas, component. Exemplary devices may be an absorber, such as a hydrogen sulfide absorber or a carbon dioxide absorber. In the figures depicted below, the absorber is a carbon dioxide absorber, although the embodiments depicted herein can be applicable to other devices.

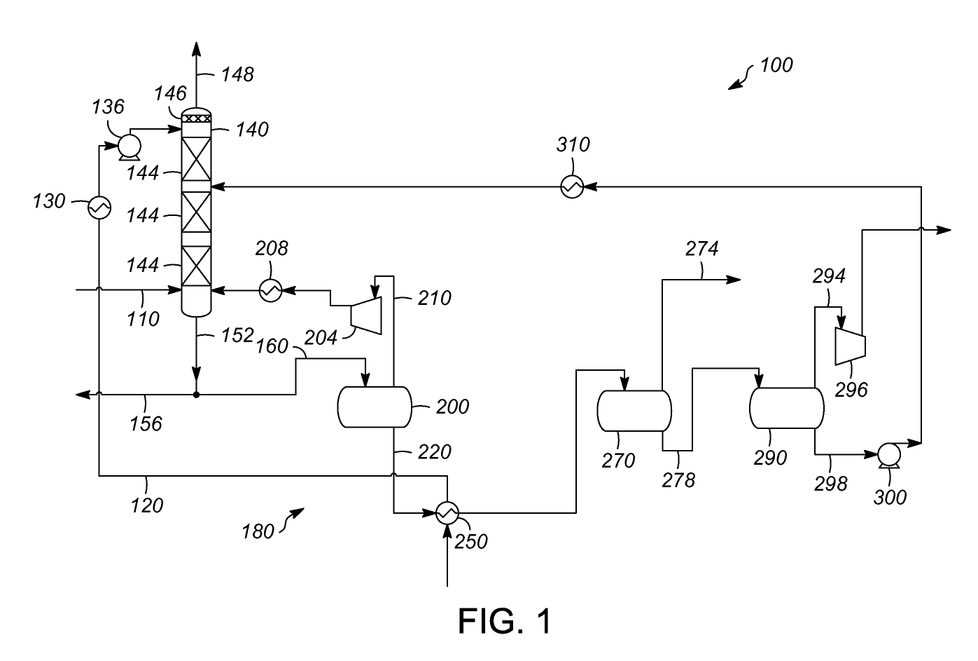

Referring to FIGS. 1-3, several versions of an acid gas removal zone 100 are depicted. Referring to the version depicted in FIG. 1, the acid gas removal zone 100 can include an absorber 140; at least one flash drum 180 or a plurality of flash drums 180, such as a high pressure flash drum 200, a medium pressure flash drum 270, and a vacuum flash drum 290; a first fluid transfer device 136; a second fluid transfer device 204; a third fluid transfer device 296; a fourth fluid transfer device 300; a lean solvent stream chiller 130; a carbon dioxide stream cooler 208; and a partially-lean solvent stream chiller 310.

The acid gas removal zone 100 can receive a feed 110, which is typically a sour gas including at least one of carbon dioxide and hydrogen sulfide, such as a syngas with unacceptable amounts of carbon dioxide and hydrogen sulfide. The sour gas can originate from an overhead stream of a hydrogen sulfide absorber, or from a Claus-plant, a coal gasification plant, a direct-oxidative process, or a sulfuric acid generation plant. Typically, the feed 110 is contacted in the absorber 140 with a solvent. Usually, the solvent can include at least one of a dimethyl ether of polyethylene glycol (sold under the trade designation SELEXOL by Dow Chemical Company of Midland, Mich.), a N-methyl pyrrolidone, a tetrahydro-1,4-oxazine (also may be referred to as morpholine), a methanol, and a mixture comprising diisopropanolamine and tetrahydrothiophene-1,1-dioxide (also can be referred to as sulfolane).

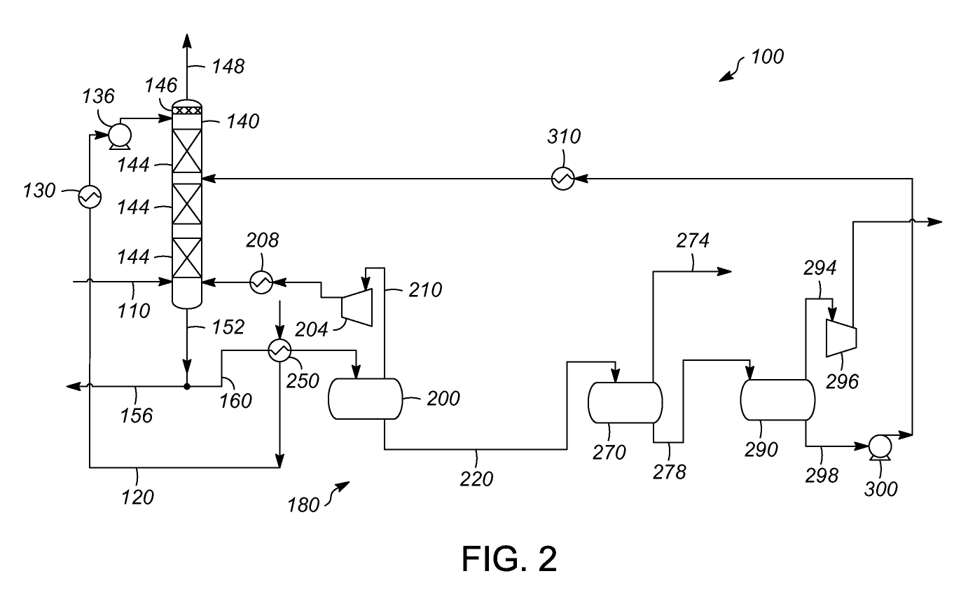

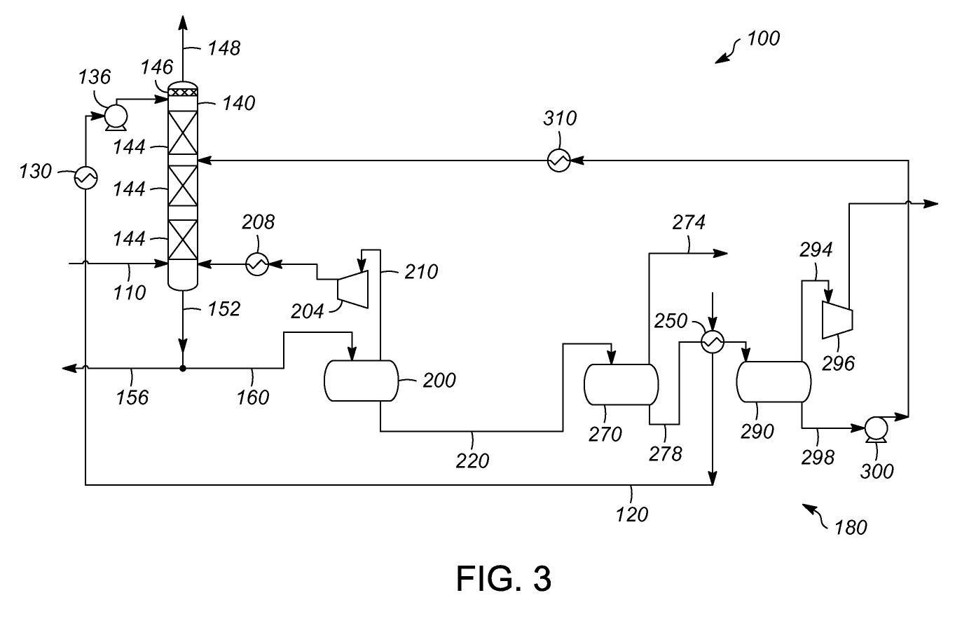

Generally, different amounts of carbon dioxide can be present in the solvent, and the streams containing the solvents can be characterized as a lean solvent stream 120, a partially-lean solvent stream 298, and a loaded solvent stream 152. In addition, a solvent stream may also include an absorber-solvent cooling stream that can typically be an incompletely-processed-partially-lean solvent stream. The absorber-solvent cooling stream may be a bottom effluent 220 (as depicted in FIG. 1) and 278 (as depicted in FIG. 3) from, respectively, the high pressure flash drum 200 and medium pressure flash drum 270, or another portion 160 (as depicted in FIG. 2) of the loaded solvent stream 152, depending on which stream 160, 220, and/or 278 can be used to cool the lean solvent stream 120.

The lean solvent stream 120 can include less than about 1 ppm, by weight, of carbon dioxide and hydrogen sulfide. The partially-lean solvent stream 298 can include about 0.5-about 5%, preferably about 0.5-about 1.5%, by mole, carbon dioxide and less than about 1 ppm, by weight, of hydrogen sulfide. The partially-lean solvent stream 298 can preferably have a carbon dioxide loading at the lower end of the range, and typically includes any suitable amount for removing impurities from the feed 110. The loaded solvent stream 152 can include about 15-about 40%, preferably about 15-about 25%, by mole, carbon dioxide and less than about 1 ppm of hydrogen sulfide. Generally, the preferred concentration of carbon dioxide can be at the upper end of the range for the loaded solvent stream 152.

The absorber-solvent cooling stream 160, 220, or 278 can typically have a greater amount of carbon dioxide than the partially-lean solvent stream 298. Generally, the absorber-solvent cooling stream 160, 220, or 278 can have an undesired amount of carbon dioxide prior to flashing the excess in one or more flash drums. Typically, the absorber-solvent cooling stream 160, 220, or 278 can have at least about 2%, even about 5%, and even more about 10%, by mole, carbon dioxide depending on the pressure of the flash drums, e.g., the high pressure flash drum 200 and the medium pressure flash drum 270, or the amount of carbon dioxide in the loaded solvent stream 152. Although the amount of carbon dioxide in the absorber-solvent cooling stream 160, 220 or 278 may overlap with the partially-lean solvent stream 298, typically the stream 298 has less carbon dioxide than the absorber-solvent cooling stream 160, 220, or 278 within a given zone 100.

The carbon dioxide absorber 140 can include one or more absorption beds 144, such as three absorption beds 144 in this exemplary embodiment, and a demister 146. Any suitable demister can be utilized, such as a vane or mesh demister. Exemplary absorbers are disclosed in, e.g., U.S. Pat. No. 6,090,356 and US 2006/0196357 A1. The carbon dioxide absorber 140 can operate at a pressure of about 2,700-about 7,000 kPa and a temperature of about −2-about 25° C. The absorber pressures can usually occur at the low end or the upper end of these ranges. Generally, the absorber 140 has higher temperatures near the bottom as the solvent flows downward and absorbs carbon dioxide. Although the carbon dioxide absorber 140 can remove carbon dioxide, other components from the feed 110 may also be removed, such as hydrogen sulfide.

The carbon dioxide absorber 140 can receive the feed 110 at a lower end, the lean solvent stream 120 at an upper end, and a partially-lean solvent stream 298 (as described in further detail hereinafter) and a stream 210 including carbon dioxide at an elevation at one of or between the two ends. The lean solvent stream 120 can pass through the exchanger 250 (as described in further detail hereinafter), the lean solvent stream chiller 130, and the first fluid transfer device 136, such as a pump 136, before entering the absorber 140. Typically, the discharge of the pump 136 can be about 2,800-about 7,500 kPa. Although the pump 136 is depicted downstream of the lean solvent stream chiller 130, it can be positioned upstream in other exemplary embodiments. Generally, the feed 110 can include a sour gas rising upward through the absorber 140. The sour gas can pass upward through the absorption beds 144 contacting the lean solvent passing downward. The solvent can absorb various gas components, such as carbon dioxide and hydrogen sulfide. Afterwards, the cleansed gas can pass through the demister 146 before exiting the absorber 140 as a treated gas, typically a syngas, stream 148.

A bottom stream 152, which can be a loaded solvent stream 152, can exit the bottom of the absorber 140. A portion 156 of the bottom stream 152 can be withdrawn and sent to a regenerator, and optionally returned as the lean solvent stream 120. Another portion 160 of the bottom stream 152 can be provided to the high pressure flash drum 200. Typically, the high pressure flash drum 200 can operate at a pressure of about 1,300-about 4,200 kPa, and a temperature range of about 4-about 25° C. Preferably, the high pressure flash drum 200 can operate at about the middle of these ranges.

The flash drum 200 can provide the stream 210 including or rich in carbon dioxide to the second fluid transfer device 204, which is typically a carbon dioxide compressor 204. In one exemplary embodiment, the stream 210 can include about 5-about 75%, by mole, carbon dioxide, about 2-about 20%, by mole, carbon monoxide, about 2-about 40%, by mole, hydrogen, up to about 2%, by mole, nitrogen, and up to about 2%, by mole, methane, as well as optionally other hydrocarbons. Subsequently, the stream 210 may be provided to the carbon dioxide stream cooler 208 prior to entering the absorber 140.

In this exemplary embodiment, the absorber-solvent cooling stream 220 can be obtained from the bottom of the high pressure flash drum 200. This bottom effluent 220 can be provided to an absorber-solvent cooling stream/lean solvent stream exchanger 250 and can have about 10-about 35%, by mole, carbon dioxide depending on the pressure of the high pressure flash drum 200. Particularly, the absorber-solvent cooling stream 220 may be used to cool the lean solvent stream 120 prior to entering the lean solvent stream chiller 130. Typically, the absorber-solvent cooling stream 220 can have a pressure of about 300-about 4,200 kPa, and a temperature of about −2-about 25° C. on an inlet side and a temperature of about −2-about 30° C. on an outlet side. Usually, a higher temperature on the outlet is preferred for the absorber-solvent cooling stream 220. Typically, the absorber-solvent cooling stream 220 can have temperatures in about the mid-point of these ranges. The lean solvent stream 120 can have a pressure range of about 300-about 1,400 kPa, and a temperature of about 20-about 50° C. on an inlet side and a temperature of about 10-about 40° C. on an outlet side. Usually, a lower temperature is preferred for the lean solvent stream 120. As discussed above, the lean solvent stream 120 can be provided to the absorber 140 for absorbing any suitable gas, such as hydrogen sulfide and carbon dioxide from the feed 110.

The absorber-solvent cooling stream 220 exiting the exchanger 250 can be provided to the medium pressure flash drum 270. The medium pressure flash drum 270 can operate at a pressure of about 130-about 1,400 kPa, and a temperature of about 1-about 25° C. A stream 274 including or rich in carbon dioxide can be flashed from the medium pressure flash drum 270 removing some of the carbon dioxide from the bottom effluent 278 and reducing the amount of material being compressed, as hereinafter described. The bottom effluent 278 including about 2-about 30%, by mole, carbon dioxide can exit the medium pressure flash drum 270 and be provided to the vacuum flash drum 290.

The bottom effluent 278 entering the vacuum pressure flash drum 290 can separate into two more streams. Particularly, a stream 294 including or rich in carbon dioxide can exit a top of the drum 290 and be received by the third fluid transfer device 296, which is typically a vacuum compressor 296. In addition, a bottom effluent 298 including a partially-lean solvent stream can exit the bottom of the vacuum flash drum 290. The vacuum flash drum 290 can operate at a pressure of about 20-about 100 kPa and a temperature of about −2-about 25° C. The fourth fluid transfer device 300, which is typically a solvent pump 300, can provide the partially-lean solvent stream 298 to the partially-lean solvent stream chiller 310 for reducing the temperature of the partially-lean solvent stream 298 before entering the absorber 140.

Generally, by utilizing the chilling duty from the absorber-solvent cooling stream 220 exiting the high pressure flash drum 200, the heat energy can be removed from the lean solvent stream 120 before entering the absorber 140 and be captured by the absorber-solvent cooling stream 220. Moreover, this stream 220 can subsequently be flashed to remove excess carbon dioxide and reduce the electricity requirements of, e.g., the vacuum compressor 296. Moreover, the carbon dioxide stream 274 exiting the medium pressure flash drum 270 can be at a sufficient pressure so as to not require additional compressing for use by downstream units or processes. Thus, the embodiments disclosed herein can utilize a flash system, namely a high pressure flash drum 200, a medium pressure flash drum 270, and a vacuum flash drum 290, to remove an absorbed gas, namely carbon dioxide, from the solvent in this preferred embodiment although other solvents may be utilized and other gases absorbed. Typically, it is preferable that the drums 200, 270, and 290 operate at a lower temperature.

As an example, the duty of the partially-lean solvent stream chiller 310 may increase, but the lean solvent stream chiller 130 duty can decrease by about the same amount. Generally, the net result is a slight decrease in the total refrigeration duty due to the decrease in solvent rates. As a further example, an about 14° C. temperature differential on the cold side of the exchanger 250 can reduce the partially-lean solvent requirements by about 9%. This reduction can decrease the total electricity requirements by about 4%. The electricity reductions can be due to lower solvent rates and about a 12% power decrease in the vacuum compressor 296. The vacuum compressor 296 power may decrease because more carbon dioxide can be removed at the medium pressure flash drum 270, which can reduce the amount of carbon dioxide compressed. The diameter of the lower section of the carbon dioxide absorber 140 can also be reduced by about 2-about 3%, reducing the volume of that vessel by about 5-about 6%.

Referring to FIG. 2, the acid gas removal zone 100 can include the same equipment, e.g., the absorber 140, the high pressure flash drum 200, the medium flash drum 270, and the vacuum flash drum 290, as discussed above. However, in this exemplary embodiment, the effluent 220 from the high pressure drum 200 is not used to chill the lean solvent stream 120. Rather, another portion 160 of the bottom stream 152, i.e., the loaded solvent stream 152, can be utilized as the absorber-solvent cooling stream 160. The lean solvent stream 120 can pass through the exchanger 250, as discussed above. Using the exchanger 250 upstream of the high pressure flash drum 200 may recycle more carbon dioxide to the carbon dioxide absorber 140.

Referring to FIG. 3, another exemplary version of the acid gas removal zone 100 can include all of the equipment as depicted in FIG. 1, but in this instance, the exchanger 250 can be downstream of the medium pressure flash drum 270. As such, the effluent 278 from the medium pressure flash drum 270 may be the absorber-solvent cooling stream 278. More carbon dioxide may be received by the vacuum compressor 296 increasing its required power. In addition, the bottom effluent 220 may flash less material from the medium pressure flash drum 270 due to being at a cooler temperature.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing, all temperatures are set forth in degrees Celsius and, all parts and percentages are by weight, unless otherwise indicated.

From the foregoing description, one skilled in the art can easily ascertain the essential characteristics of this invention and, without departing from the spirit and scope thereof, can make various changes and modifications of the invention to adapt it to various usages and conditions.

1. A process for increasing an efficiency of an acid gas removal zone, comprising:
A) passing an absorber-solvent cooling stream through a heat exchanger to warm the absorber-solvent cooling stream with a lean solvent stream before removing at least a portion of the carbon dioxide in the absorber-solvent cooling stream; and
B) returning a partially-lean solvent stream to an absorber.

2. The process according to claim 1, further comprising chilling the partially-lean solvent stream before returning to the absorber.

3. The process according to claim 1, wherein the solvent streams comprise at least one of a dimethyl ether of polyethylene glycol, a N-methyl pyrrolidone, a tetrahydro-1,4-oxazine, a methanol, and a mixture comprising diisopropanolamine and tetrahydrothiophene-1,1-dioxide.

4. The process according to claim 1, wherein the solvent streams comprise a dimethyl ether of polyethylene glycol.

5. The process according to claim 1, wherein the absorber is a carbon dioxide absorber.

6. The process according to claim 1, wherein the absorber is a hydrogen sulfide absorber.

7. The process according to claim 1, further comprising passing the absorber-solvent cooling stream through at least one flash drum before entering the heat exchanger.

8. The process according to claim 7, further comprising passing the absorber-solvent cooling stream through at least one flash drum after exiting the heat exchanger.

9. The process according to claim 1, further comprising passing the absorber-solvent cooling stream through a high pressure flash drum before the heat exchanger, and through a medium pressure flash drum and then a vacuum flash drum after exiting the heat exchanger.

10. The process according to claim 9, further comprising chilling the lean solvent stream before entering the absorber.

11. The process according to claim 9, further comprising flashing a stream including carbon dioxide from the medium pressure flash drum.

12. The process according to claim 1, further comprising passing the absorber-solvent cooling stream through at least one flash drum after exiting the heat exchanger.

13. The process according to claim 12, wherein the at least one flash drum comprises a high pressure flash drum.

14. The process according to claim 7, further comprising passing the absorber-solvent cooling stream through a plurality of flash drums before entering the heat exchanger.

15. The process according to claim 14, wherein the plurality of flash drums comprises a high pressure flash drum and a medium pressure flash drum.

16. A process for reducing the duty of a lean solvent stream chiller, comprising:
passing an absorber-solvent cooling stream through a heat exchanger to warm the absorber-solvent cooling stream while cooling a lean solvent stream before the lean solvent stream enters the lean solvent stream chiller.

17. The process according to claim 16, further comprising passing the absorber-solvent cooling stream through at least one flash drum to flash carbon dioxide before a partially-lean solvent stream enters a chiller.

18. An acid gas removal zone, comprising:
A) an absorber adapted to receive a stream comprising at least one of hydrogen sulfide and carbon dioxide, and a lean solvent stream;
B) a heat exchanger adapted to warm an absorber-solvent cooling stream using the lean solvent stream provided to the absorber;
C) a high pressure flash drum, a medium pressure flash drum, and a vacuum flash drum adapted to receive the absorber-solvent cooling stream; and
D) a partially-lean solvent stream chiller adapted to receive a partially-lean solvent stream from the vacuum flash drum and to provide the partially-lean solvent stream to the absorber.

19. The acid gas removal zone according to claim 18, wherein the heat exchanger is adapted to receive the absorber-solvent cooling stream before entering the high pressure flash drum.

20. The acid gas removal zone according to claim 18, wherein the heat exchanger is adapted to receive the absorber-solvent cooling stream after entering the high pressure flash drum and before entering the medium pressure flash drum.
